(19) United States
(12) Patent Application Publication
(10) Pub. No.: US 2004/0208499 A1
(43) Pub. Date: Oct. 21, 2004

(54) Stabilized buoy platform for cameras, sensors, illuminators and tools

(76) Inventor: David E. Grober, Venice, CA (US)

Correspondence Address: David E. Grober, 616 Venice Blvd., Venice, CA, 90291, US

(21) Appl. No.: 10/771,763

(22) Filed: Feb. 4, 2004

Related U.S. Application Data
(63) Continuation-in-part of application No. 10/236,847, filed on Sep. 7, 2002, now Pat. No. 6,718,130.

(51) Int. Cl. G03B 17/00

(52) U.S. Cl. 396/428

(57) ABSTRACT

A stabilized buoy platform for cameras, sensors, illuminators and tools, which incorporates a buoy, a stabilizing mechanism and a stabilized payload platform thereon. Affixed to the stabilized payload platform are sensors and tools which include cameras and sensor systems integrated with the appropriate illumination technology, all of which are stabilized both for ease of tacking, identification and monitoring of targets. The invention also provides for other species of objects and tools, applicable in surveillance, security, protection and tasks where tools need to be stabilized to perform their intended functions.

### CROSS REFERENCE TO RELATED APPLICATIONS

This is a continuation-in-part of application Ser. No. 10/236,847, filed Sep. 7, 2002, pending, incorporated by reference herein.

### BACK GROUND OF THE INVENTION

1. Field of the Invention

The invention relates to a stabilized buoy platform for supporting cameras, sensors, antennas, fire fighting apparatus, and other tools. Additionally the invention relates to the combined self leveling and self correcting abilities of keeping the supported objects stable on a buoy platform.

2. Brief Description of the Related Art

The present inventor has invented a stabilized platform for use, e.g., on a boat which moves up and down on ocean waves, as disclosed in U.S. Pat. No. 6,611,662, incorporated by reference herein. In addition, the present inventor has invented a stabilized camera for mounting on a buoy.

It is desirable for security and surveillance reasons to illuminate and track objects from a buoy, aiding human and computers to recognize, identify and track objects within the sensor's field of view. Stabilization of both the camera/sensor and illumination means, in varying spectrums, is invaluable to increasing image clarity, recognition and sensor range. The more stable these images, the easier and more accurately the subject object can be identified. In Grober “Stabilized Camera and Marker Buoy for Media Coverage of Aquatic Events” U.S. patent application Ser. No. 10/236,847, one embodiment carries a camera and audio microphone. It would be desirable to have a physical configuration of the stabilization platform that includes multiple cameras, multiple sensing capabilities and corresponding illumination. Different embodiments would also include “tools” to undertake a variety of physical operations which are linked to the ability of Grober Ser. No. 10/236,847 to capture images and sound, move to different locations and initiate physical operations using equipment onboard the buoy. Some of these operations are already claimed in Grober Ser. No. 10/236,847 and include GPS location reference, motorized propulsion and raising and lowering anchors and ground tackle.

Stabilizing cameras and lights on buoys for security and surveillance purposes has been impractical because buoy motion prevents a stable image. With the introduction of autonomous security systems, computers are being relied upon to interpret camera and sensor imagery from video, infrared, and other sources. During surveillance if the object is moving randomly through the sensor's field of view due to buoy motion, it will be a more difficult if not impossible task identifying the object or it's path of motion. In addition, various types of illumination or spectrums may be required to “see” objects within the sensor's field of view. Stabilization of the illumination source is therefore also desirable.

### SUMMARY OF THE INVENTION

In one embodiment, the stabilized buoy, whose cameras and sensors could monitor the underside of an oil terminal pier, would also incorporate heat and fire sensors. Should a fire occur underneath the pier, the buoy, remote controlled, either by human or computer means, moves to a fire fighting position, aims a stabilized water or chemical cannon at the flames to contain or put out the fire. Without the ability to have the cameras, sensors and tools such as the fire extinguisher device stabilized, both the surveillance and the response by the tool would be severely limited if not impossible in moving waters.

In another embodiment, the stabilized buoy is a wharf piling painter. An automated paint gun can be programmed to paint even, continuous strokes of paint. This is accomplished because the buoy's stabilization system stabilizing the imaging sensor to clearly sense the location of the piling and the non-painted areas on the piling. The paint gun tool, which is also stabilized against the motion of the buoy, can evenly apply paint to the non-painted areas because it is also stabilized against the motion of the buoy. Similar results can be obtained using other type of tools such as sand blasters.

Stabilization methods upon the buoy platform can be varied. One such embodiment is described in Grober U.S. Pat. No. 6,611,662. Other methods can be used without limiting the scope of the present invention. The method of actuating the stable platform would be dependent upon the device being stabilized. A high pressure fire hose or paint sprayer gun might require linear actuators, hydraulic actuators or other high force actuators to be most effective

In any embodiment where the physical location of the level sensor on the stabilized payload platform plate might compromise the sensor, such as intense heat on the payload platform of the fire fighting embodiment, the second sensor package including the level sensor, such as that described in Grober U.S. Pat. No. 6,611,662 can be placed at the same location as the first sensor package containing rate sensors. By employing additional sensors to measure the joint angles of the frameworks about the three orthogonal axes, the angular relationship between the framework joints can be computed. By computing the joint angles from a known starting point, such as a hard stop where one axis rests against a second axis, such as where the pitch axis framework would rest against the roll axis framework, or where the two axis are sensed to be aligned at a known angle by a proximity sensor, then by assigning a level sensor value to that point, the position of the payload plate in relation to level will always be known the same as if the level sensor were to be placed directly upon the payload plate as disclosed in Grober U.S. Pat. No. 6,611,662.

In one embodiment, the measurement of the joint angles is sensed by shaft encoders at the framework joints, or motor encoders on the motor/actuators driving each axis, or a combination of both.

In another embodiment, shaft brakes, attached to the motor drive shafts, will brake and lock the payload platform from movement, thus preventing sensitive devices upon the payload platform from being damaged due to sudden or uncontrolled motions should the stabilization system be shut off or fail.

The types of sensors which can be used are varied and can include but are not limited to data from GPS, satellites, horizon radiation sensors, magnetometers, rate sensors, gyro sensors and level sensors. The types of actuators which can be used are varied and can include but are not limited to motors and gears, linear actuators, hydraulic, and magnetic.

In firefighting applications, where fire boats, probably at least 30′ long with humans would be unable to approach a burning object, a low profile buoy, such as the remote controlled buoy in Grober Ser. No. 10/236,847 can approach a fire, easily keep its circular shape cool with a shower-like stream of water, keep cameras trained on the fire, and use water cannon mounted on the stabilizer to pump water or chemical retardants into flames.

The stabilized cameras and water/chemical cannons would provide accurate aim and maximum effectiveness in relation to non-stabilized systems. In situations where the burning mass, such as a floating pool of oil must be separated or split up into sections to effectively fight the fire, a stabilized water cannon can be accurately aimed and utilized.

In a further embodiment, the stabilized platform can move and stabilize the payload plate 360 degrees in two orthogonal axes, thus providing global surveillance around the buoy platform. This includes above the water using air based sensors such as cameras, and simultaneously below the water using underwater sensors such as cameras, sonar or other relevant sensors.

In another embodiment the payload platform being above the center of the pitch and roll axis, has an extension arm which projects downward below the location of the pitch and roll axis so as to stabilize a lower payload platform in conjunction with the upper payload platform. The result is that the invention is able to stabilize sensors and devices on the top stabilized plate as well as sensors and devices on the lower stabilized plate which can be extended into the water. In a surveillance mode, this would allow surveillance above the horizon with sensors such as cameras, and surveillance below the surface with devices such as sonar. A further actuating mechanism, such as a hydraulic piston located in the extension arm the projects downward below the location of the pitch and roll axis, can compensate for rise and fall of the buoy platform to the extent of the piston arm extension in the lower section. This would keep a sensor, such as a sub surface sensor at a fixed level, for instance 1 foot below the surface.

In another embodiment, the stabilized platform is large enough to support a man with a surveillance device such as binoculars, and other tools which will be more accurate when stabilized. The stabilized platform can be lightweight, foldable and portable and moved from vehicle to vehicle, allowing its use, not only on buoys, but also on vehicles such as helicopters, boats and land vehicles.

### DRAWINGS

FIG. 1 is a side perspective view of a buoy platform with linear actuator stabilized platform mounted with a camera and fire extinguisher tool in accordance with a first embodiment of the invention;

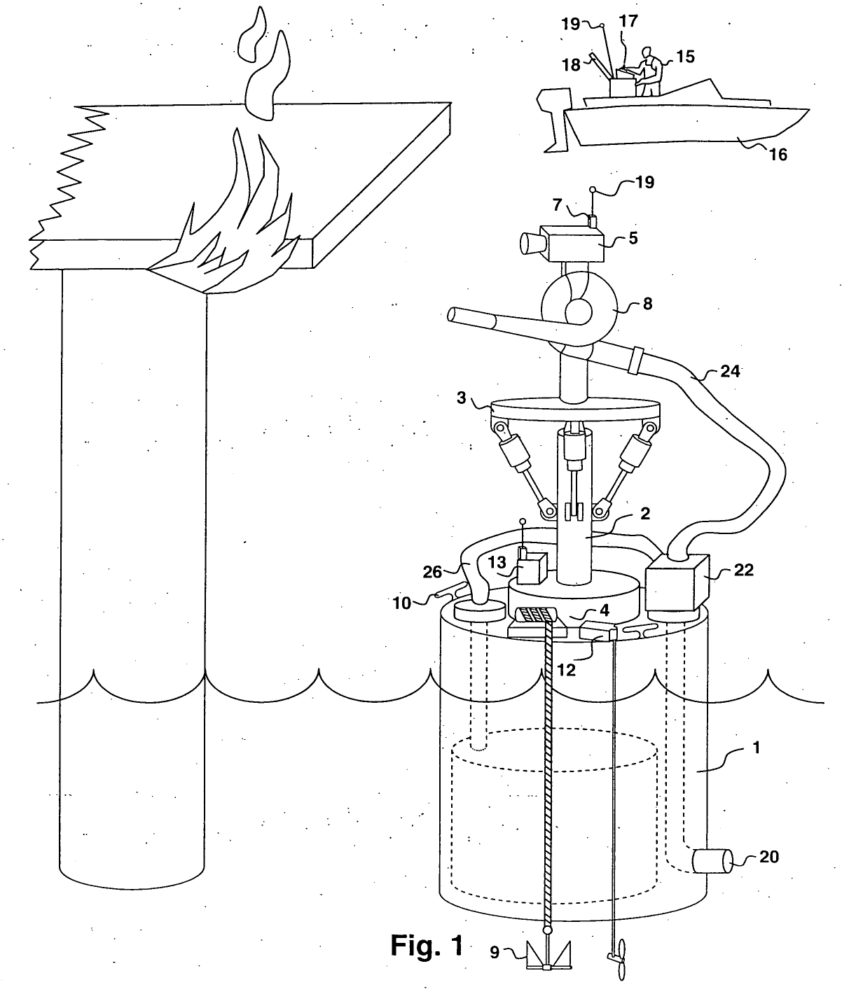

FIG. 2 is a side perspective view of a buoy platform with a three axis stabilized motor-gear platform mounted with a camera and paint gun tool in accordance with a second embodiment;

FIG. 3 is an enlarged side view of a linear actuator stabilized platform suitable for use in the first or second embodiment to replace the structure on top of the buoy platform 1, in FIG. 1 or FIG. 2;

FIG. 4 is a top view of the linear actuator stabilized platform of FIG. 3;

FIG. 5 is an enlarged perspective view of a motor-gear stabilized platform with a series of cameras and sensors on four sides and a swivel sensor and illumination device on top for use in lieu of the structure on top of the buoy platform 1, in the embodiments of FIG. 1 or FIG. 2;

FIG. 6 is a buoy platform showing the stabilizer with an upper and lower platform, the upper platform being for air surveillance, the lower platform being for underwater surveillance;

FIG. 7 is a variation of the stabilized platform of FIG. 3 or FIG. 4 which is collapsible to create a portable stabilized platform which is shown stabilizing a man with binoculars.

FIG. 8 is the buoy platform of FIG. 1 including a stabilized seat for an operator; and the stabilized paint sprayer tool.

### DETAILED DESCRIPTION OF THE PREFERRED EMBODIMENTS

A floating platform 1 is made of a buoyant material or water tight enclosure that is of a size and shape capable of supporting the weight of a tool 8, camera 5, stabilizing system 2, which is shown as the device from a base plate 4, to a stabilized payload plate 3, a ground tackle system 9, propulsion system 12, and an operator if applicable in certain embodiments. The outer shell is preferably of a shock absorbing material that will preclude damage to passing vessels and the platform should the two come into physical contact. The size, shape and material of platform 1 will vary depending on the weight and dimensions of the stabilization system, tools and camera or sensors which the buoy must support in various sea conditions.

Stabilizing system 2, preferably a three axis stabilized electronic waterproof head, such as the Perfect Horizon stabilization head (made by Motion Picture Marine in Marina del Rey Calif.) or other stabilization device, is securely mounted on top of buoy float 1. The stabilizing head 2 is preferably remote controlled and/or autonomous. An example of a suitable electronic stabilization head is also disclosed and claimed in U.S. Patent; Grober U.S. Pat. No. 6,611,662, Autonomous, Self Leveling, Self Correcting Stabilizing Platform, incorporated by reference herein. Note that a two dimension stabilization system may also be used, but a three dimension stabilization system is preferred.

Tool support platform 3 provides an attachment mechanism for securing tool 8, such as a fire nozzle, camera 5, and any other objects which need to be stabilized from the motion of the buoy. The distance of the tool above the water can be varied by adjusting components that would determine height and may include the use of a jack screw as an element of base plate 4.

A non electronic stabilizing head such as a gimbal tripod can also be used in which case a camera operator preferably would be positioned directly on the camera buoy platform, or in a remote location with remote controls for directing the camera position. Where the camera stabilization head is electronic and/or where it is remotely controlled, there may also be a manual override option in which case a camera operator may be positioned on the buoy if desired.

Camera 5 is waterproof or contained in a weather resistant housing. The camera used in the preferred remote operation mode is capable of transmitting the lensed image signal to a remote operator 15 via transmitter 7.

Camera 5 is equipped with controls which can be remotely operated by commands from the remote operator. Preferably the commands in remote operating mode include a minimum of camera on/off, zoom, iris control, focus, pan and tilt. Ground tackle or anchoring system 9, may include some or all of the following; windlass (anchor winch), line, chain and an anchor, and is capable of securing the buoy at a fixed geographic location on the water. The size and shape of the ground tackle is variable and dependant on the local conditions.

Cleats 10 are for towing, securing or hoisting the buoy into position, and are located at least in one position and preferably four positions spaced around the buoy. An optional propulsion unit 12 can move the buoy on the water to various locations, and when used in the preferred remote operation mode, is remote controlled for on/off and steering direction, and is attached directly to the side of the floating platform 1 or recessed within a motor well formed as part of the buoy.

In one embodiment, the operator 15 is stationed at a remote location such as on a nearby boat 16. The operator views the transmitted image 18, and utilizes a control panel 17 to remotely control the stabilization system, the tool, and the camera system. In the case of a fire on a pier 14, the operator can remotely move the buoy 1 into position, clearly see the pier and fire through camera 5, and operate the fire nozzle tool 8, to suppress the fire. The fire nozzle tool 8 can shoot water which comes through inlet pipe 20, pumped by pump 20, through fire hose 24. In an alternate embodiment, tank 30 may hold a fire retardant which moves under pressure or is pumped through retardant fire hose 26 to the fire nozzle tool.

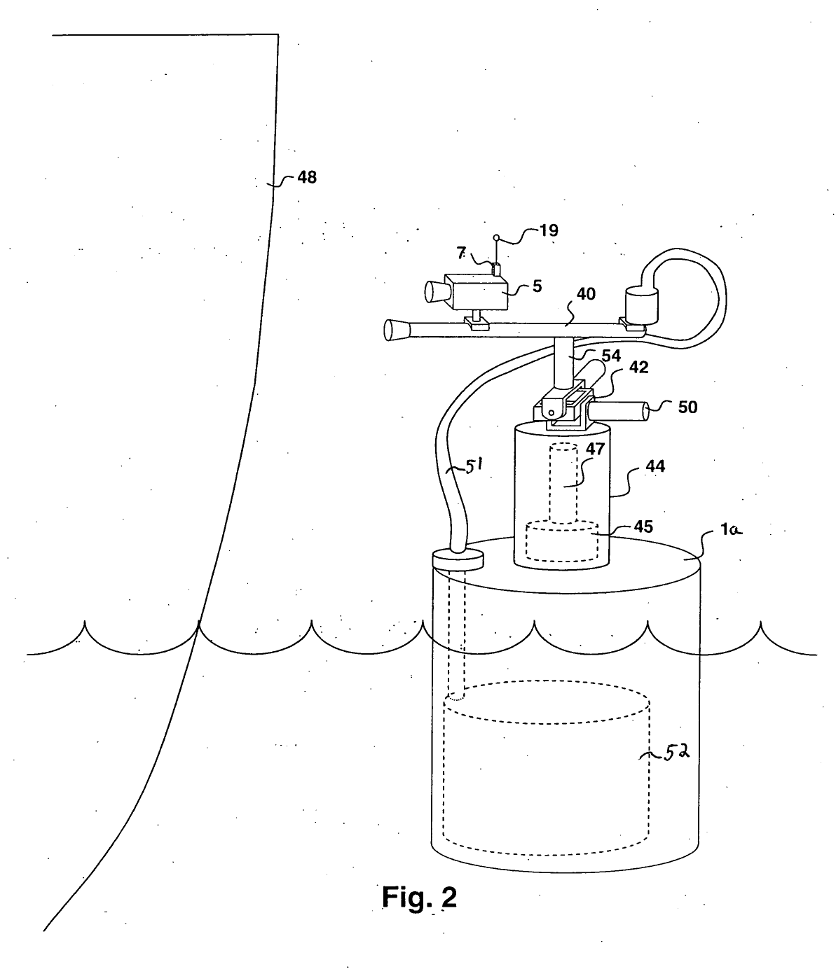

### FIG. 2

Buoy platform 1A has a painting tool 40, which is firmly attached to the top of the stabilized platform's top motor 54. as in U.S. Pat. No. 6,611,662. The stabilizing platform is preferably remote controlled and/or autonomous and provides an attachment for securing a painting tool 40 and camera 5, and any other objects which need to be stabilized from the motion of the buoy. The distance of the tool above the water can be varied by adjusting components that would determine height and may include the use of a jack screw 47 as an element of base plate 44. In this embodiment, the buoy float with its stabilized painting tool are painting the side of a ship 48.

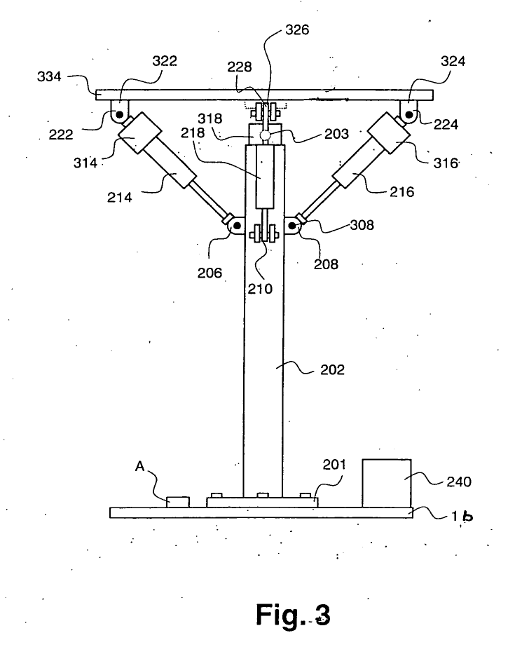

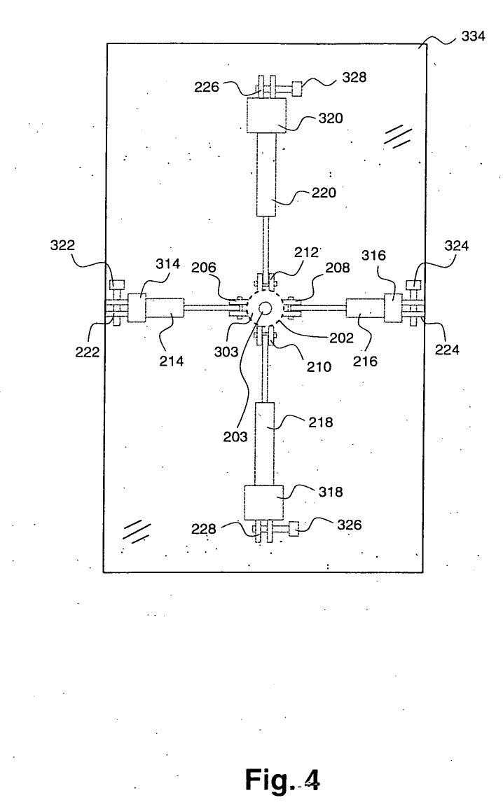

### FIGS. 3 AND 4

FIG. 3 showing a side view and FIG. 4 showing a top view, illustrate a self-stabilized platform, such as in U.S. Pat. No. 6,611,662 to Grober, incorporated by reference herein. The self-stabilized platform includes a pedestal base plate 201 which is firmly secured to the buoy float 1b. A rigid post 202 is attached to the base plate 201 and supports a universal joint 203. The universal joint 203 connects the post 202 to a center or balance point of the payload platform and acts as a pivot point. Attachment points 206, 208, 210, and 212 on post 202 are sleeve bearings or other rotatable bearings. Attached to each of these sleeve bearings is a combination motor M and linear actuator 214, 216, 218, and 220. An opposing end of each of the linear actuators is attached to a sleeve bearing 222, 224, 226, and 228 which is securely attached to payload platform 334.

At one or more of the moving joint locations which include; 203, 206, 208, 210, 212, 222, 224, 226, 228, there is attached a sensor such as a shaft encoder, 306, 308, 310, 312, 322, 324, 326, 328. Each motor has a motor encoder, 314, 316, 318, 320. An encoder 303 may be attached to sense the movement of the universal joint 203.

The purpose of the sensors or encoders at one or more of the joint angles is to measure the joint angle which the CPU central processing unit 240 will then use to calculate the position of payload plate 334 in reference to buoy float 1b. This can be mathematically calculated in ways known to those skilled in the art. One way could include starting the payload plate 334 at an angle such that it hits a hard stop, such as the “end of motion” point on the respective linear actuator for that specific axis. In sensing motion from a given starting point or angle, the CPU will know the position angle of payload plate 334 in relation to the level data given off by sensor package A, which includes level sensor data relative to gravity. Sensor package A as a single unified sensor can also incorporate sensors that sense rate motion, rotational motion, or other rates and angles of motion depending on the type of sensor. In this case, though sensor package A may physically be one sensor, it is sensor that incorporates the two functions of providing both rate sensor data and level sensor data. For instance, if level sensor located at A indicates that the pitch axis is positive 10 degrees, and the motor encoder or shaft encoder for the pitch axis indicates that payload plate 334 is positioned 100 motor turns from a pre-determined hard stop, such as the end of travel point of the actuator's motor, then the location of payload plate is 10 degrees positive plus or minus the number of degrees represented by the 100 motor turns counted by the pitch axis encoder, thus giving the location of the payload plate 334. The level sensor data of A, when coupled with the joint angle data from at least one shaft encoder or motor encoder per axis, will provide the position of payload plate 334 at any moment in time.

Where a level sensor attached to the payload plate such as described in Grober U.S. Pat. No. 6,611,662, would provide the level information of payload plate 334, and thus correct for errors and anomalies over time of the rate sensors in package A, as described in Grober U.S. Pat. No. 6,611,662, in situations where a sensor upon the payload plate is prohibitive, such as intense heat experienced in fire fighting, then the level sensor located on payload plate 334 can be moved to the buoy float 1b such as to location A. The resolution which can be provided is dependent upon the resolution of the encoders. The number of shaft sensors or encoders necessary will be at least one to sense the motion for each axis of the invention. In FIGS. 3 and 4, though a shaft or motor encoding device is shown at each joint, the working embodiment may only need a single shaft or encoder per each axis; pitch, roll and yaw, and would be evident to one skilled in the art.

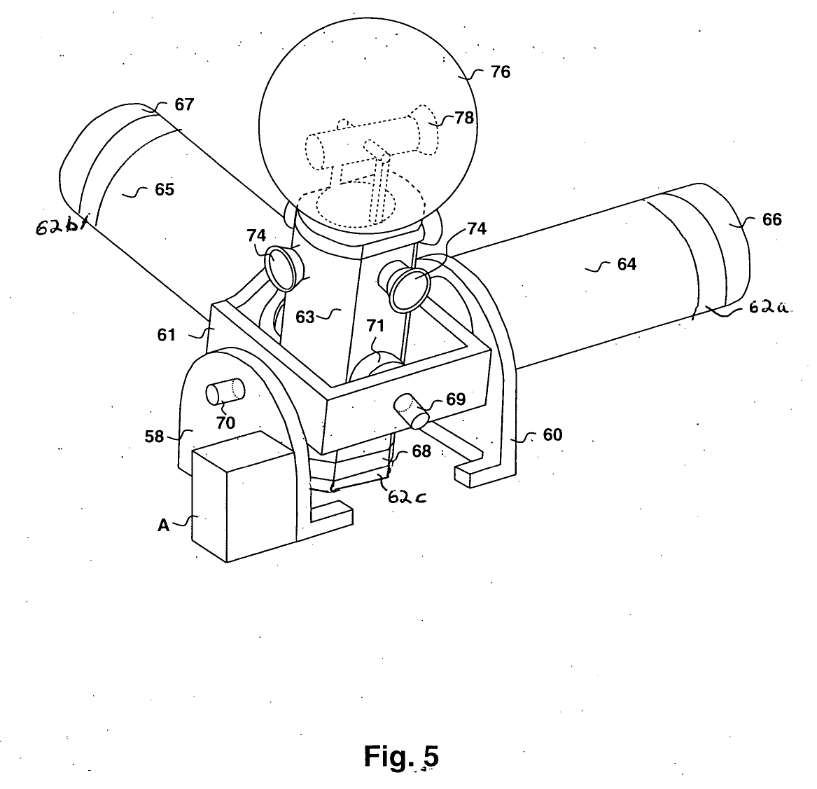

### FIGURE 5

FIG. 5 shows the stabilization system for a multi camera/sensor and illumination embodiment. Upright face plate 58 and opposing faceplate 60 support the pitch axis 61 through bearings located orthogonally to roll axis 63 at shaft 69. Sensor package A is attached to an upright face plate 58. It may alternatively be firmly attached to the buoy float to which the upright face plates are firmly mounted. Thus, it is directly or indirectly fixed to or with respect to the buoy platform.

Pitch axis 61, rotates around a shaft located at shaft encoder 70 and moves orthogonally to roll axis shaft 69, allowing for motion greater than 180 degrees and allowing pointing of pitch axis 61 both upright and downward and allowing sensor observation both above and below the rotational center of the pitch axis. Pitch axis 61 is operated by a motor 64 (e.g., with a gear) and encoder 66. Pitch axis 61 can rotate greater than 180 degrees. Roll axis 63, which incorporates the appropriate motor, gear and encoder combination, rotates around the axis running through shaft 69.

Attached to roll axis 63 is payload dome 76 which is attached to the motor output of motor assembly 63. Inside payload dome 76 is a payload platform 78 which can swivel and point it's payload throughout a minimum of 180 degrees or greater area of the dome. Attached to roll axis 63 can be a variety of tools 74 including cameras, sensors and illuminators.

A further embodiment derived from U.S. Pat. No. 6,611,662 is that a level sensor placed upright on axis 63, may not work inverted when axis 63 pitches through 180 degrees or more. Multiple locations for placement of motor encoders 66, 67, and 68, and shaft encoders 69, 70 and 71, allow the firm placement of sensor package A at any location on the stabilized platform or attached buoy. Motor brakes on each motor 62a, 62b, 62c, are able to lock their respective axis and prevent payload platform movement should the stabilizer be shut off or the power fail.

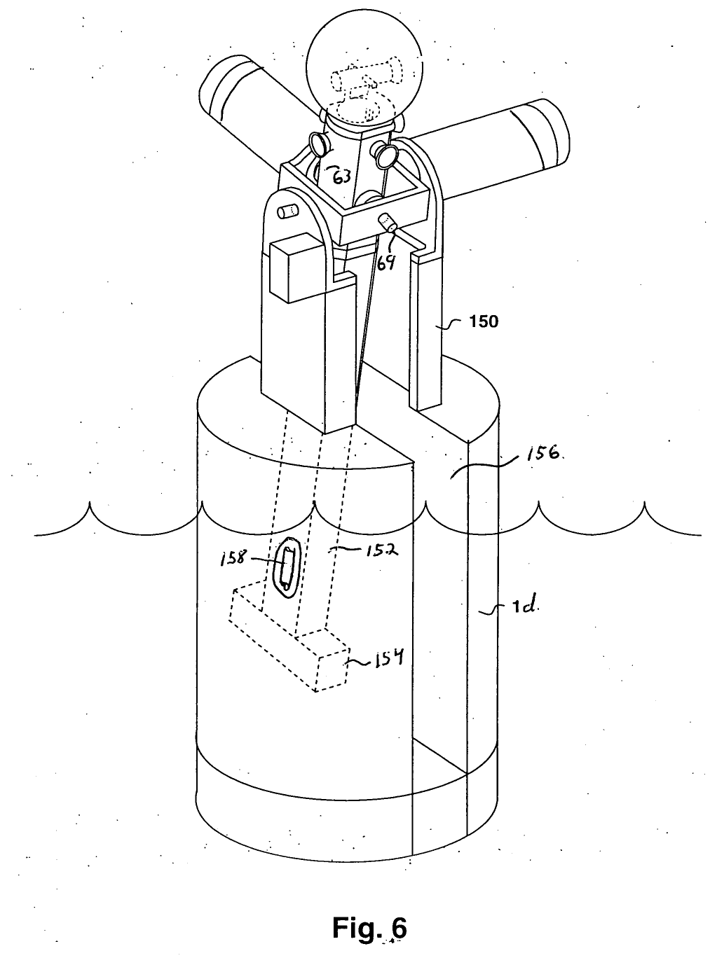

### FIG. 6

FIG. 6 shows the stabilization system of FIG. 5. An extension arm 152 is attached to axis 63 below axis pivot 69. Attached to downward extension arm 152 is an underwater sensor device 154. Buoy platform 1d has a cut-out section 156, which allows extension arm 152 and sensor device 154 to swing freely through the buoy platform. Stabilizer riser 150, raises the stabilizer mechanism off the buoy platform the desired distance. Inside extension arm 152 is a piston mechanism 158 which can move up or down to further keep the sensor 154 at a determined level beneath the water surface.

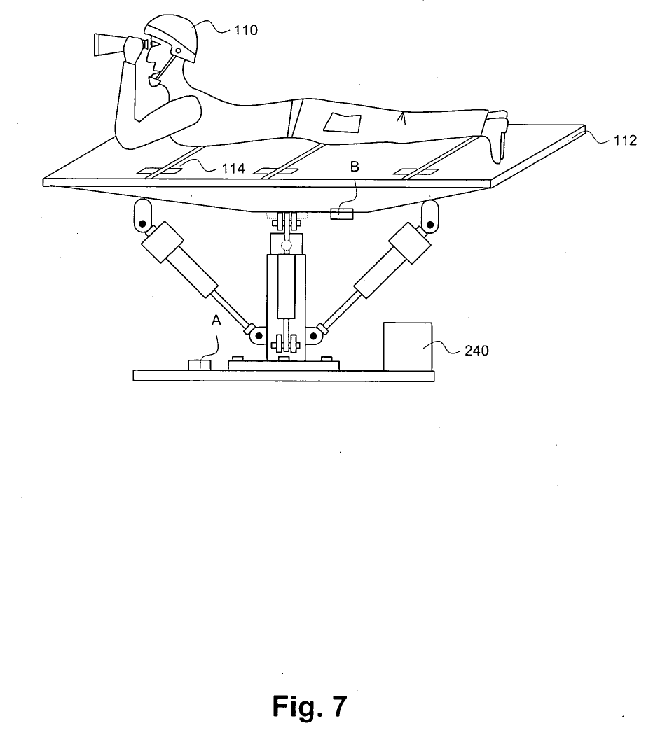

### FIG. 7

FIG. 7 shows the stabilized platform of FIG. 3 wherein the payload platform 112 is foldable at joints 114. An observer 110 with binoculars 116, or with other tools, is resting on or attached to the platform 112. Payload platform 112 is firmly attached to stabilization system 116 which is described in detail in FIG. 3.

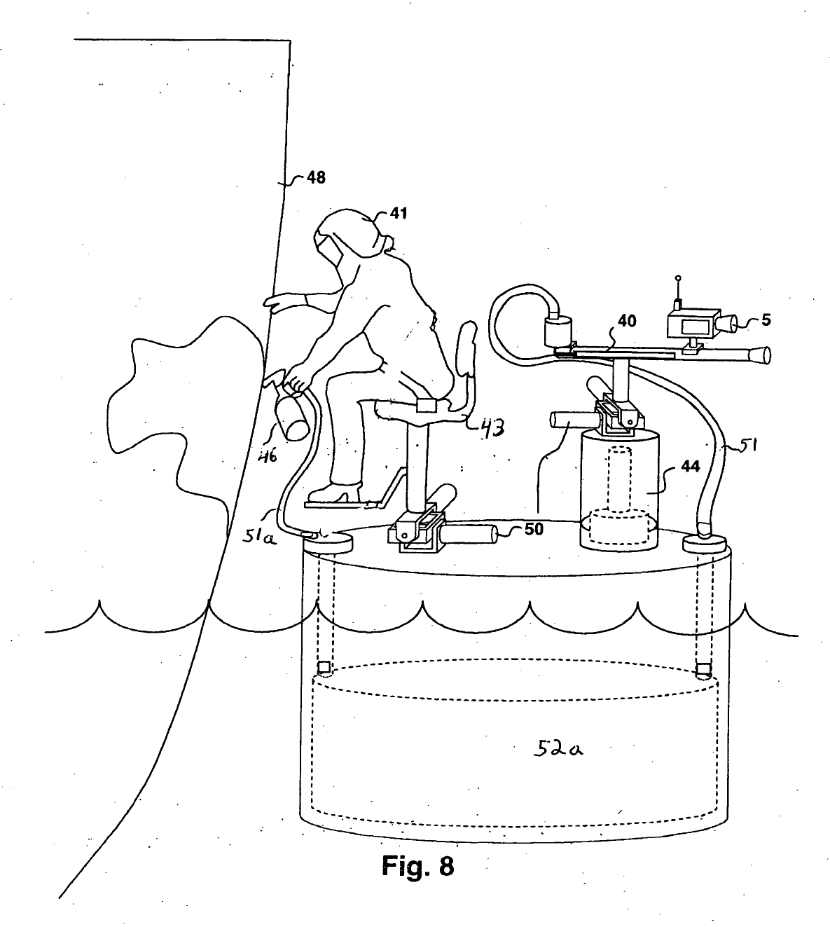

### FIG. 8

FIG. 8 shows the buoy platform of FIG. 2 with the buoy platform enlarged to accommodate a man 41, sitting upon a stabilized seat 43, using the a paint spray gun tool 46 which is attached by hose 51a to paint reservoir 52a. The man is shown painting the side of ship 48. The man can also use the stabilized paint gun tool 40, which is attached by hose 51 to paint reservoir 52a. Camera 5 is attached to paint spray gun tool 46.

While the particular invention has been described with regards to particular embodiments, it is recognized that additional variations of the present invention may be devised without departing from the inventive concept, and would be evident to those skilled in the art.

1. A stabilized buoy platform comprising:
(a) a buoy float having a support platform for mounting a stabilized platform on the buoy float;
(b) a stabilizing system mounted on the platform for stabilizing a singular or a plurality of devices and/or tools from the movements of the buoy float in one, two or three axis which include pitch, roll and azimuth; and
(c) at least one device and/or tool mounted on the stabilizing system.

2. The stabilized buoy platform of claim 1 wherein the device is an image receiving device

3. The stabilized buoy platform of claim 1, wherein the image receiving device is selected from the group comprising a camera, sensor, thermal imager, infrared sensor and GPS.

4. The stabilized buoy platform of claim 1 wherein the device and/or tools emit or projects light, illumination or radiation in various spectrums or frequencies.

5. The stabilized buoy platform of claim 1 wherein the device and/or tools emit or projects particles of physical mass including, but not limited to; water, chemicals, paints, solvents, sand, rock or other projectiles.

6. The stabilized buoy platform of claim 1 wherein the device and/or tools are, but not limited to; a paint brush, drill, welding iron and/or gun, and can accomplish tasks which are, but are not limited to; painting, drilling, welding, sandblasting and/or shooting.

7. The stabilized buoy platform of claim 1 wherein the device and/or tools can be operated from a remote location via wire or wireless control.

8. The stabilized buoy platform of claim 1 wherein the device and/or tools can be operated from a remote location via wire or wireless control by a human or a computer.

9. The stabilized buoy platform of claim 1 wherein the device and/or tools can be operated from the buoy by direct control of a human operator or a computer stationed on the buoy platform.

10. The stabilized buoy platform of claim 1 wherein the device and/or tools are sensors and
(a) a computer recognizes movement within the stabilized sensor image; and
(b) the computer sends signals to the stabilizer and/or camera which control the stabilizer and/or camera to track the movement of the object seen within the stabilized image.

11. The stabilized buoy platform of claim 10 wherein the device and/or tools take an action based upon the commands from a person or a computer.

12. The stabilized buoy platform of claim 1 wherein the stabilizer uses the method of maintaining a level payload plate by use of a single sensor package located on the base and which senses motion of the base about one, two or three axis, and
(a) there are sensor means to sense the joint angles of the frame components, and
(b) uses the joint angles to determine the position of the payload plate in reference to level provided by a level sensor on the base plate or incorporated within the first sensor package
(c) keeps the payload plate level or at a pre-determined position in relation to level.

13. The stabilized buoy platform of claim 12 wherein the stabilizer uses the method of maintaining a level payload plate by use of a single sensor package located anywhere on the buoy platform or upon the stabilized plate, and
(a) uses the joint angles to determine the position of the payload plate in reference to level provided by a level sensor located anywhere upon the buoy or the stabilizer.
(b) keeps the payload plate level or at a predetermined position in relation to level.

14. The stabilized buoy platform of claim 13 wherein the joint angles ofthe frame parts are monitored from a known point, such as a hard stop, with a shaft encoder or other sensing device, and
(a) the joint angle data is used to determine the position of the payload plate in reference to level provided by a level sensor located anywhere upon the buoy or the stabilizer, and
(b) the payload plate is kept level or at a pre-determined position in relation to level.

15. The method of calculating the joint angle of all the moving parts, which,
a. when computed in relation to the level provided by a level sensor, which may be located anywhere on the buoy or the stabilizer, and
b. when taken in relation to the position of the sensor package will allow the CPU to determine the position of the stabilized payload plate and
c. will move the payload platform to maintain level or any other chosen angle to the level.

16. The method of stabilizing the payload platform using one or more sensor packages, singularly or in plurality have the capability to sense motion of the base and level in one two or three orthogonal axis by;
(a) electrically or mechanically sensing the joint angles of the framework and
(b) sending the joint angle data to the CPU, and
(c) the CPU using joint angle data in conjunction with level sensor data to determine the position of the stabilized payload platform and
(d) using rate of motion sensors to provide rate motion used to move the payload plate
(e) correcting errors or drift in the payload plate by comparison of the location of the payload plate with the position of level provided by the level sensor.
(d) maintaining the payload plate level or at a predetermined position in relation to level.

17. The stabilized buoy platform of claim 1 wherein the means for movement of the frame sections in relation to each other is accomplished by any singular type or plurality of types of actuators including but not limited to linear actuators, motors and gears, magnets or hydraulics.

18. The method of claim 16 wherein stabilizing a singular or plurality of payload platforms about a central point,
a. the pitch axis is supported such that it can rotate or swivel 360 degrees and
b. the roll axis is supported such that it can rotate or swivel 360 degrees orthogonal to the pitch axis, and
c. the azimuth axis is supported such that it can rotate or swivel 360 degrees orthogonal to the roll axis.

19. The stabilized platform of claim 1 wherein the stabilized platform can be separated from the buoy platform, disassembled or folded to become a portable stabilization platform, which can rest on, or be attached to any moving object where stabilization is required.

20. The stabilized buoy platform of claim 1 wherein motor brakes are attached to the moving shafts to prevent unwanted shaft motion should the power be shut off or fail.
